(19) United States
(12) Patent Application Publication
(10) Pub. No.: US 2026/0178874 A1
(43) Pub. Date: Jun. 25, 2026

(54) ANALOG NEURAL NETWORK

(71) Applicant: Neu Edge Ltd, Oxford (GB)

(72) Inventors: Yuhang SONG, Oxford (GB); Walter Thomas Rombold Goodwin, Oxford (GB)

(21) Appl. No.: 19/541,830

(22) Filed: Feb. 17, 2026

Related U.S. Application Data
(63) Continuation of application No. 19/143,832.

(30) Foreign Application Priority Data
Dec. 29, 2022 (GB) 2219806.3

(51) Int. Cl. G06N 3/04; G06N 3/049; G06N 3/08

(52) U.S. Cl. CPC G06N 3/04; G06N 3/049; G06N 3/08

(57) ABSTRACT

An analog neural network is described comprising: a plurality of layers connected to form an electrical circuit having an input and an output, the input suitable for receiving an electrical signal corresponding to an input example and the output corresponding to an output of the neural network. Each layer comprises elements connected together, where the elements comprise: at least one programmable electronic element representing a weight of the neural network; at least one non-linear element; at least one amplifier block; an error element. Each layer also comprises a measurement element for measuring a change in an electrical signal across the error element.

### CROSS-REFERENCE TO RELATED APPLICATIONS

This application is a continuation of and claims priority to U.S. patent application Ser. No. 19/143,832 filed Jun. 26, 2025, titled “Analog Neural Network,” which claims priority under 35 U.S.C. § 371 to Patent Cooperation Treaty (PCT) Application No. PCT/GB2023/052913 filed Nov. 8, 2023, titled “Analog Neural Network,” which claims benefit of priority to United Kingdom Patent Application No. 2219806.3 filed Dec. 29, 2022, titled “Analog Neural Network,” all of which are hereby incorporated by reference in their entirety.

The present disclosure relates to hardware neural networks which are neural networks implemented using electronic circuits.

### BACKGROUND

Neural networks are widely used today in many domains including but not limited to: self-driving vehicles, robotics, medical image analysis, object recognition, facial recognition, manufacturing plant control, telecommunications network security and many more. Often neural network computation, during training of a neural network and/or during operation of a neural network to compute predictions, is resource intensive and time consuming.

In order to speed up and improve the efficiency of neural network computation, computing hardware such as graphics processing units and multi-tile processing units are available.

The examples described herein are not limited to examples which solve problems mentioned in this background section.

### SUMMARY

Examples of preferred aspects and embodiments of the invention are as set out in the accompanying independent and dependent claims.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A first aspect of the disclosed technology is an analog neural network comprising:
a plurality of layers connected to form an electrical circuit having an input and an output, the input suitable for receiving an electrical signal corresponding to an input example and the output corresponding to an output of the neural network;
each layer comprising elements connected together, where the elements comprise:
at least one programmable electronic element representing a weight of the neural network;
at least one non-linear element;
at least one amplifier block;
an error element;
and wherein each layer also comprises a first measurement element for measuring an electrical signal V of the error element, and
a second measurement element for measuring a weight input U of the programmable electronic element.

As a result of connecting the elements together and using the amplifier block as well as the measurement elements, the analog neural network is able to implement predictive coding whereby credit assignment is carried out without using backpropagation. Predictive coding is a type of neural network computation used for training neural networks whereby error signals are available throughout a neural network as a result of an electrical steady state in the neural network rather than by being passed between layers of the neural network using backpropagation. Credit assignment is the problem of determining how a change to neural network weights will affect the output of the neural network.

Preferably the analog neural network comprises
a first clamp for clamping the input to the electrical signal corresponding to the input example;
a second clamp for clamping the output to an electrical value; and
a measurement and update element comprising functionality to, in response to the first and second clamps being active and the electrical circuit being in a steady state, receive input from the first and second measurement elements and to update the programmable electronic element using the input from the first and second measurement elements.

By using the measurement and update element it is possible to obtain signals from the measurement elements at an appropriate time in order to enable predictive coding and efficient credit assignment. The signals are obtained in an extremely efficient manner so that the resulting analog neural network is trained potentially faster than a corresponding neural network implemented using a graphics processing unit (GPU).

The inventors note that analog neural networks trained in this way are more stable on analogue hardware than software neural networks trained in digital space e.g. on central processing units (CPUs) or GPUs and then transferred to analogue hardware. The inventors also recognize achieving the latter remains extremely difficult at any reasonable scale. Given that analog neural network hardware is ultra-efficient, getting stable networks onto it (by in-situ learning) is a significant benefit. Preferably the electrical value represents a ground truth label of the input example and the input example is a training example. Preferably the electrical value is a ground truth label of the input value instead of a small nudge from the current prediction value towards the ground truth label value as in an alternative approach. Thus the second clamp is relatively large in magnitude and is more than a mere perturbation towards the target electrical value. By using a relatively large second clamp rather than a mere perturbation, the measurement signal is greater than electrical noise inherently present in many instantiations of analogue hardware, enabling accurate machine learning.

Preferably, the measurement and update element is arranged to update the programmable electronic element using at least the input V from the first measurement element and the input U from the second measurement element in order to train the neural network. In this way the analog neural network is trained extremely efficiently.

Preferably the error element comprises any one or more of: a capacitor, a resistor. In this way the measured signal (such as voltage or current) over an error element relates to the effect the whole electrical circuit has on the error element. By use of a capacitor, a value related to the measured signal is stored locally to the error element. Since the error elements are located physically in each layer the measured (and potentially stored) signal in the error elements is immediately available in the respective layer and does not have to be computed and passed using back-propagation.

Preferably, the measurement and update element comprises an analog combiner. An analog combiner is an analog element which takes two analog signals as input and produces an analog output signal which combines the two signals. In an example the analog combiner produces an output signal which is related to a function of the two analog signals. A non-exhaustive list of examples of suitable functions is: addition, multiplication, weighted multiplication or any other aggregation function. Using an analog combiner is an efficient and effective way to implement the measurement and update element in analog form. Being able to do the measurement and update in the analog domain brings efficiency and accuracy since conversions between analog and digital signals are avoided. Using an analog process throughout in this way is extremely efficient. Noise is reduced since there is reduced analog to digital conversion and digital to analog conversion. By using an analog process to apply the update it is possible to take into account device variability since the analog circuit itself performs the computation. Using the programmable electronic element to enable fully end-to-end analog neural networks gives these types of hardware neural networks a boost (i.e. orders of magnitude energy and/or speed gains) over software neural networks deployed using GPUs. Preferably the analog combiner produces one or more voltage pulses which are input to the programmable electronic element giving an efficient way to update the programmable electronic element.

Preferably the measurement and update element is digital and uses a memory to store computed updates to be applied to neurons of the analog neural network. Using a memory enables the updates to be applied after the measurements of U and V so as to not influence the measurements of U and V.

Preferably, the programmable electronic element, non-linear element, amplifier block and error element are connected in series in any order. Since any order is usable the topology can be tailored to fit manufacturing or space constraints.

Preferably, the measurement and update element is configured to make an update to a programmable electronic element only after measurement of U and V for neurons of the analog neural network to be updated. Doing so enables measurement of U and V to be independent of the update.

Preferably the plurality of programmable electronic elements comprises a cross-bar array of electronic elements, which may be implemented as programmable resistive elements such as memristors or another form of programmable resistive element. Using such a cross-bar array gives a compact form factor which is efficient and accurate. Using such a cross-bar array of resistive elements directly replicates the mathematics of matrix-vector multiplication, a key operation within deep learning.

In another aspect of the technology there is a data centre comprising at least one analog neural network as described in any of the examples above and herein. However, the technology is not limited to use in data centres. The analog neural networks described herein are used in Internet of Things devices and other edge computing devices in some cases.

In another aspect of the technology there is a method of training the analog neural network of any of the examples herein, the method comprising:
clamping the electrical signal at the input to an electrical signal representing the training example;
further clamping the output to the electrical value representing the label of the training example,
and
in response to the electrical circuit being in a steady state, measuring electrical signal V and electrical signal U; and
updating the programmable electronic element using V and U.

This is an extremely efficient method of training since due to the use of the error elements there is no backpropagation involved.

Preferably, using the measurement to update the programmable electronic element comprises applying the measurement in analog form to the programmable electronic element. Using an analog process throughout in this way is extremely efficient. Noise is reduced since there is reduced analog to digital conversion and digital to analog conversion.

Preferably, the method of training comprises, in response to clamping the electrical signal at the input to an electrical signal representing the training example, whilst the output is not clamped,
measuring an electrical signal Error_f using the first measurement element; and
updating the programmable electronic element using V and U and Error_f.

This learning rule is found to be very effective in practice for training analog neural networks and involves seeking to keep error the same as it was during a forward pass of the neural network rather than seeking to reduce error to zero.

In another aspect there is a method of operating the analog neural network of any preceding example to compute a prediction, the method comprising:
clamping the electrical signal at the input to an electrical signal corresponding to an input example; and
in response to the electrical circuit being in a steady state, outputting an analog signal at the output. In some cases the analog signal at the output is converted to digital form.

The method makes a prediction with the network end-to-end fully analog (no digital computing happens and no digital to analog conversion, or analog to digital conversion happens in between layers of the analog neural network. The end-to-end analog method gives an extremely efficient and low power method of computing a prediction from a neural network.

In another aspect there is a method performed by an analog neural network comprising:
receiving an electrical signal corresponding to an input example at an input of an electrical circuit comprising a plurality of layers;
within each layer, processing the electrical signal by passing the electrical signal through a plurality of elements connected together, where the elements comprise:
at least one programmable electronic element representing a weight of the neural network;
at least one non-linear element;
at least one amplifier block;
an error element;
a first measurement element;
a second measurement element; and
wherein the method comprises
using a first clamp to clamp the electrical signal at the input to the electrical signal corresponding to the input example;
using a second clamp to clamp an output of the electrical circuit to an electrical value representing a ground truth label of the input example; and
in response to the first and second clamps being active and an equilibrium state in the analog neural network, using the first measurement element to obtain an electrical signal V of the error element, and using the second measurement element to obtain a weight input U of the programmable electronic element.

The method is an efficient way of achieving a predictive coding process. Predictive coding is a successful model of information processing in the cortex. The intuition behind predictive coding is that each neural network layer tries to predict the activity of the next neural network layer. An error between a prediction of the activity of the next neural network layer and the current actual activity of the next neural network layer is defined. Predictive coding assumes that learning (i.e. neural network training) takes place via the dynamics of two quantities. A first dynamic is that neuron activity reduces the energy of half the square of the error. A second dynamic is that a weight of a neuron reduces the energy of half of the square of the error. In this way, if the energy of the error reduces to zero, the neuron activity and neuron weight remain constant and are said to stay still such that the model is making a satisfying prediction. When an error is introduced at a specific layer (such as the output layer), the neuron activity changes across the network to propagate or distribute the error across the network. Thus the weights are also changed to reduce the error across the neural network.

Preferably the method comprises:
using U and V to update the programmable electronic element using an analog update.

In this way in situ training of an analog neural network is achieved efficiently and accurately.

Preferably, in response to clamping the electrical signal at the input to an electrical signal representing the training example, whilst the output is not clamped, measuring an electrical signal Error_f using the first measurement element; and updating the programmable electronic element using V and U and Error_f. In this way a learning rule is implemented which seeks to keep the error observed during a forward pass constant (i.e., the learning rule tries to keep V close to Error_f, instead of trying to reduce V to zero). This type of learning rule is found to work well in practice.

Preferably, updating the programmable electronic element using V and U and Error_f comprises updating the programmable electronic element by a change of weight which is approximately equal to the negative difference between the error V observed when the analog neural network is at equilibrium with both the first clamp and the second clamp in place, and the error Error_f observed when the analog neural network is at equilibrium with only the first clamp in place, times the weight input U.

It will also be apparent to anyone of ordinary skill in the art, that some of the preferred features indicated above as preferable in the context of one of the aspects of the disclosed technology indicated may replace one or more preferred features of other ones of the preferred aspects of the disclosed technology. Such apparent combinations are not explicitly listed above under each such possible additional aspect for the sake of conciseness.

Other examples will become apparent from the following detailed description, which, when taken in conjunction with the drawings, illustrate by way of example the principles of the disclosed technology.

### BRIEF DESCRIPTION OF THE DRAWINGS

FIG. 1 is a schematic diagram of a compute node with an analog neural network deployed at a data centre or other computing entity;

FIG. 2 is a schematic diagram of an analog neural network with a plurality of layers and with an exploded view of one of the layers;

FIG. 3 is a circuit diagram of an analog neural network with two layers;

FIG. 3A shows part of a circuit used to implement a learning rule which seeks to keep error constant;

FIG. 4 is a circuit diagram of an example of a layer of an analog neural network;

FIG. 5 is a circuit diagram of an analog neural network with two layers and suitable to train the analog neural network;

FIG. 6 is a circuit diagram of an analog neural network with two layers and suitable to compute a prediction;

FIG. 7 is a circuit diagram of a plurality of programmable electronic elements in a layer of an analog neural network;

FIG. 8 is a circuit diagram of another plurality of programmable electronic elements in a layer of an analog neural network and showing a cross-bar array;

FIG. 9 is a flow diagram of a method of training an analog neural network;

FIG. 10 is a flow diagram of a method of computing an inference using an analog neural network;

FIG. 11 is a schematic diagram of a host computing device hosting an analog neural network.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is made for the purpose of illustrating the general principles of the present technology and is not meant to limit the inventive concepts claimed herein. As will be apparent to anyone of ordinary skill in the art, one or more or all of the particular features described herein in the context of one embodiment are also present in some other embodiment(s) and/or can be used in combination with other described features in various possible combinations and permutations in some other embodiment(s).

Neural networks are typically deployed in software on a GPU or CPU. In some cases specialist neural network accelerators such as multi-tile processors, field-programmable gate arrays (FPGAs) or custom application specific integrated circuits (ASICs) may be used. However, there is still a need to improve efficiency and reduce power requirements of neural network computation without detriment to accuracy.

The inventors have recognized that a bottleneck in neural network processing is the credit assignment problem whereby it has to be determined how a hypothetical change to values of neural network weights will affect a final output of the neural network. In neural network computation, credit assignment is performed using a backpropagation of error algorithm which explicitly computes a derivative of an output of the neural network with respect to each parameter (neural network weight).

The inventors have recognized that by implementing a neural network in hardware as an analog neural network it is possible to significantly improve efficiency and to reduce power requirements without detrimenting accuracy. This is achieved by using analog hardware with voltage and current relationships such as Ohm's Law and Kirchoff's current law to compute the same or similar mathematical function as a software neural network, but using analog electric circuit components rather than a digital computer. There are good theoretical reasons which indicate that using such an analog neural network allows a speed-up over existing software neural networks (deployed on GPUs or multi-tile processors) by several orders of magnitude.

However, training an analog neural network is not as straightforward as in conventional software-based approaches. The inventors have recognized that variability in hardware makes backpropagation extremely difficult and also makes it very difficult to transfer a neural network which has been trained in software form onto an analog neural network structure. Therefore the inventors have developed a way to enable in-situ learning through integration of hardware with a novel learning algorithm.

Training analog circuits in the same way as a neural network in software is challenging. This is because (among other things) analog circuits have substantial device variability introduced during fabrication which is not modelled by a software neural network. This variability arises due to imperfections in the fabrication process such as in the etching or the cleaning and causes both differences between components within a wafer, as well as between wafers. While many of these errors are random, some are systematic and hence do not ‘average out’. Attempts to train neural networks in software with hardware-aware models to simulate variability do not scale well, as it is impossible to exhaustively characterise the imperfections of any given analog circuit capable of running a neural network's computations. Thus, even such best efforts fail to transfer networks onto analog hardware without a performance drop. By contrast “in situ training” refers to attempts to train neural networks directly on the target analog hardware. Again, however, hardware imperfections can lead to backpropagation computing incorrect gradients (because the calculations involved rely on characterising the hardware) and this often destabilises training or results in worse performance. To ameliorate such problems the inventors have developed a way to train an analog neural network in situ on the hardware itself that has more favourable properties than the backpropagation algorithm.

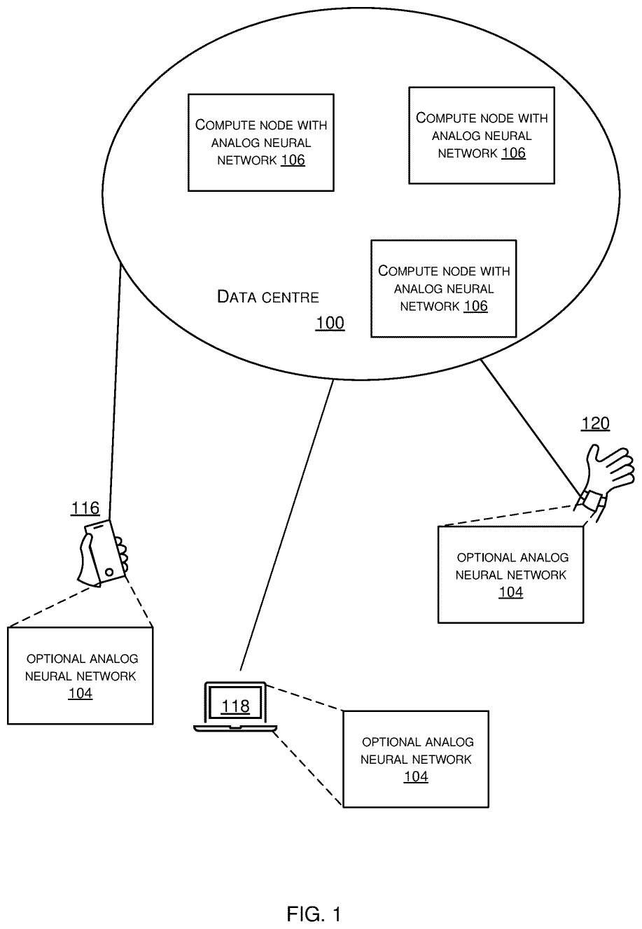

FIG. 1 is a schematic diagram of a compute node with an analog neural network 106 deployed at a data centre 100. In FIG. 1 there are three compute nodes shown in data centre 100 although in practice there are many tens or hundreds of compute nodes. One or more of the compute nodes in the data centre 100 host an analog neural network such as an analog neural network in the examples described herein. Client devices such as end user computing devices, or other computing entities, which do not have an analog neural network in them, are able to access the data centre and make use of the computing functionality including the analog neural network functionality.

In some examples, client devices such as those illustrated in FIG. 1 have analog neural network hardware in them. Thus FIG. 1 shows analog neural networks 106 as optional inside a desk top computer 118, smart phone 116, smart watch 120. The client devices are able to use the analog neural network services provided by the data centre, and/or use their own internal analog neural network resources.

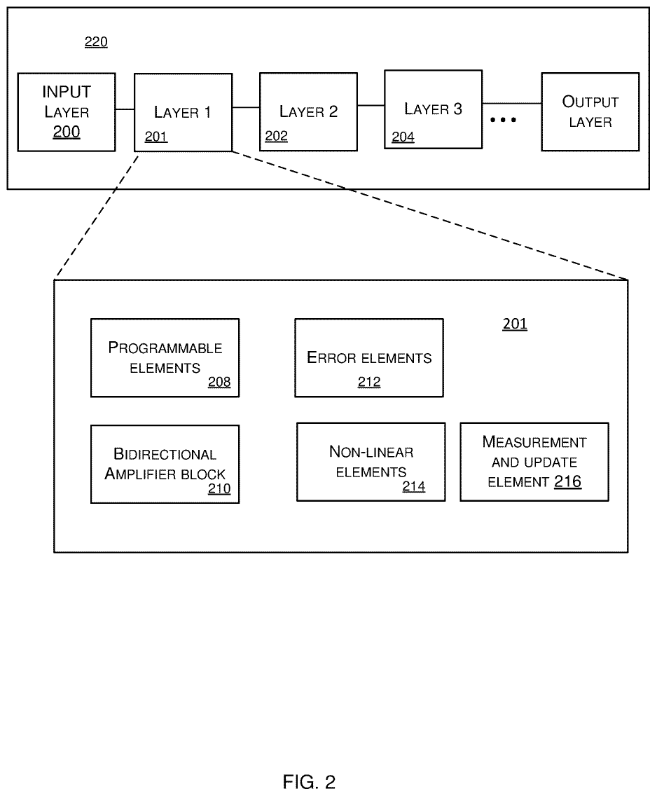

FIG. 2 is a schematic diagram of an analog neural network 220 with a plurality of layers 200, 201, 202, 204, 206 and with an exploded view of one of the layers 201. In the example of FIG. 2 four neural network layers are shown although in practice there may be many more layers as indicated by the dots in the figure. The layers are connected together as indicated schematically in FIG. 2 and together form an electrical circuit.

An electrical signal input to input layer 200 (after digital to analog conversion if appropriate), is processed by the input layer 200 and proceeds to layer 1, 201, is processed by layer 1, 201, proceeds to layer 2, 200, is processed by layer 2, proceeds to layer 3, is processed by layer 3 and so on until the electrical signal has been processed by all the layers and reaches the output layer from which the electrical signal is output. The electrical signal is a representation of an example, which is a data item such as an image, video frame, numerical value, categorical value, embedding vector, or other data item.

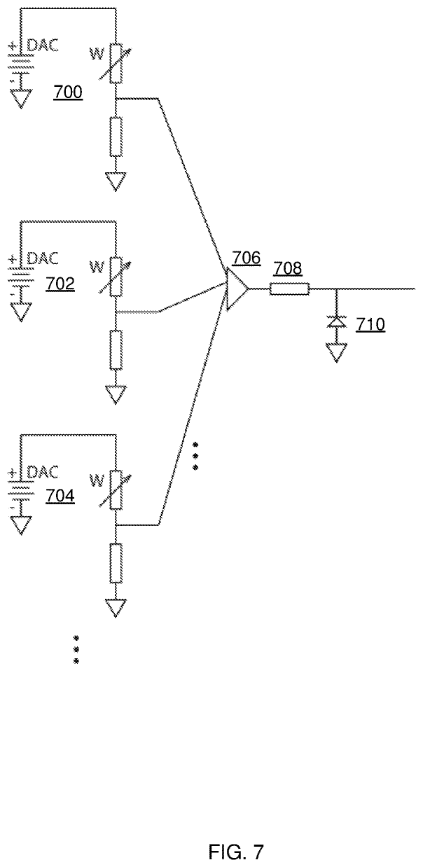

Each layer comprises a plurality of nodes (also referred to as neurons), each node having at least one associated weight. In some cases each node has a plurality of incoming signals each of which is weighted and then combined at the node as illustrated in FIG. 7 described later. Layer 1, 201 in FIG. 2 is shown in an exploded view to show electrical components in the layer comprising: at least one programmable element 208, at least one amplifier block 210, at least one error element 212, at least one non-linear element 214 and at least one measurement and update element. Each layer of the analog neural network 220 has at least one programmable element 208, at least one amplifier block 210, at least one error element 212 and at least one non-linear element 214; however, the order in which those elements are connected together may vary between layers. The neural network also has a measurement and update element 216. In some cases there is one measurement and update element per neuron. In some cases there is only one measurement and update element per layer so that the single measurement and update element is shared between neurons in the layer. Other numbers of measurement and update elements 216 are possible depending on the space and resources available.

A programmable element 208 stores a weight of a node of the neural network layer. In an example, a programmable element 208 is a memristor, however, it is not essential to use a memristor. A memristor stores information about an amount of charge that has passed through it and is a type of electrical component. The programmable element 208 is bidirectional, that is, it is able to conduct an electrical signal in either a forward direction from the input of the neural network towards the output of the neural network, or in a reverse direction towards the input of the neural network. A non-exhaustive list of examples of programmable element 208 is memristor, resistor ladder, phase-change memory, and certain other non-volatile memories.

The amplifier block 210 is bidirectional and is any electronic element which is able to amplify an electrical signal where the electrical signal is passing either away from or towards an input of the neural network. In some cases the amplifier block is a single amplifier that has a bidirectional response, or a group of at least two unidirectional amplifiers connected to each other “head to tail” such that a head of one amplifier is connected to the tail of the other amplifier and vice versa. Having such an amplifier block, where there are two unidirectional amplifiers connected to each other “head to tail” means that driving one end of the amplifier block drives its other end. Having a response in a backward direction means that driving the output of the amplifier drives its input.

An error element is a resistor with digital measurement capability and digital storage, or a capacitor or any other electronic element over which a measured signal relates to the effect the whole electrical circuit has on the element. An error element is bidirectional in that it is able to conduct an electrical signal either away from an input of the neural network or towards an input of the neural network.

A non-linear element 214 is a diode or other electronic element capable of implementing a non-linear transfer function of the neural network.

FIG. 2 shows an example of how an analog neural network is constructed so as to emulate a software artificial neural network. The term “input” is used to refer to electrical signals at input nodes of the whole artificial neural network. An input represents a training example in the case of training, or a test example in the case the neural network is being used for inference. The term “weight input” is used to refer to electrical signals received at a neuron in a hidden layer of the neural network. Due to a layered construction of a neural network, the weight input of a hidden layer comprises output signals from a previous layer of the neural network according to the particular topology of the neural network. Mathematically each neural network layer implements a matrix multiplication of the weight input to the layer with a set of weights (or parameters) followed by a nonlinear transformation. In circuitry, the matrix multiplication may be performed by using a crossbar with each programmable element being a resistive element, for example, a memristor. The weight parameters are thus implemented using programmable elements, which may be implemented as memristors. The nonlinear transformation can be applied by any nonlinear circuit component, such as diodes. The outputs of one layer feed into, and become the weight inputs of, the next layer according to the neural network topology. To prevent signal diminishment as a signal passes through each layer, a set of amplifier blocks amplify the output signals. The outputs of the final layer are the output of the network and represent the network's prediction. Inputs to the network as a whole are provided to the first layer of a cascade of layers making up the neural network. The analog circuitry is configured such that the equilibrium voltages (or currents) at the output for a given input signal are related to (such as by being generally proportional to or other ways of being related) the result of a forward pass of an equivalent (software) artificial neural network ANN under an input signal related in a similar way (such as generally proportional to).

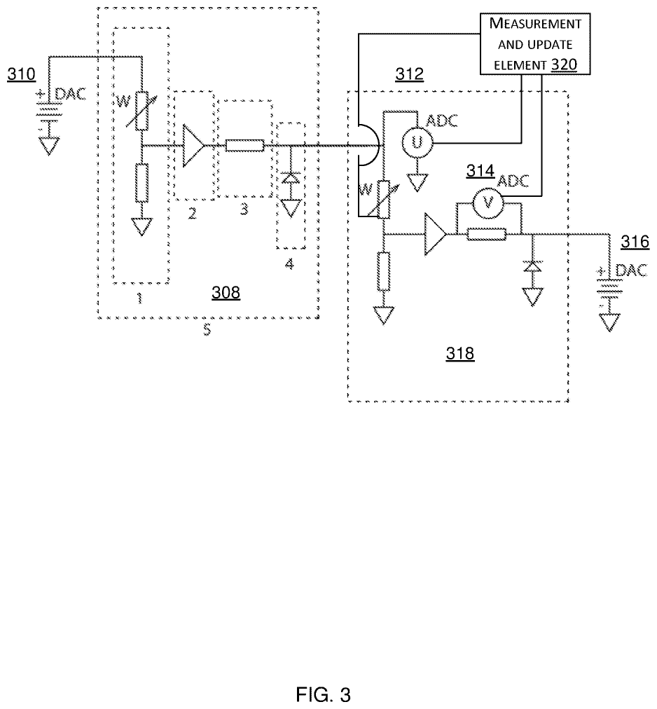

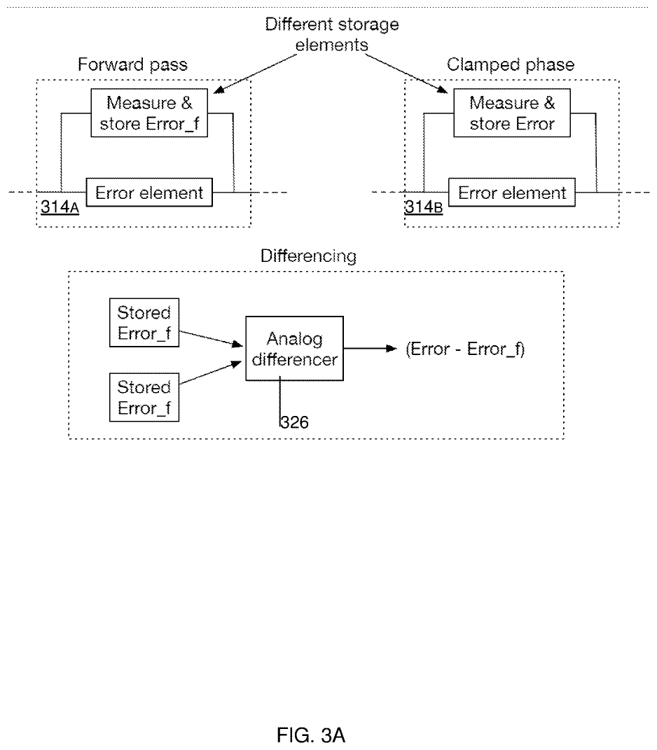

FIG. 3 is a circuit diagram of an analog neural network with two layers 308, 318. It is possible to have more than two layers 308, 318 by concatenating more layers. Each layer 308, 318 in FIG. 3 shows a single neuron made up of the four elements described above with reference to FIG. 2; that is, a programmable electronic element 1, an amplifier block 2, an error element 3 and a non-linear element 4, connected in series. Each layer may also have one or more measurement elements 312, 314 as described in more detail below. Although only one neuron is shown per layer, in practice there are many hundreds or more neurons per layer. The reference numerals 1, 2, 3, 4 are omitted in the second layer 318 for clarity. The analog neural network of FIG. 3 has an input 310 and an output 316. Both the input 310 and output 316 have an associated digital to analog converter during training, and output 316 has an associated analog to digital converter during prediction. An input to the neural network may receive an example in digital form which is converted to analog form and then input at input 310. More detail about output 316 is given below.

In the example of FIG. 3 a single neuron in a first layer 308 is shown connected to a single neuron in a second layer 318. However, in practice a single neuron from the first layer 308 is connected to each of a plurality of neurons in the second layer 318 and in the case of a fully connected arrangement, is connected to all neurons in the second layer 318.

In the example of FIG. 3 the electronic elements in each layer are connected in series in the same order, however it is possible to use different orders in different layers.

In the example of FIG. 3 the programmable electronic element is a memristor denoted by a variable resistor and the symbol W, as well as an amplifier block and another resistor creating a voltage divider so that the voltage input to the diode is not ground.

In the example of FIG. 3 the error element 3 is a resistor. In the example of FIG. 3 the non-linear element 4 is a diode. However, as mentioned above other types of non-linear element or error element may be used.

In the example of FIG. 3 the second layer 318 comprises a measurement element 314 which measures a voltage across the error element and optionally carries out an analog to digital conversion ADC. The measurement element measures a current rather than a voltage in some cases. The measurement element reads a measurement from the error element and sends the measurement to measurement and update element 320 which is analog and/or digital processing circuitry.

In the example of FIG. 3 the second layer 318 comprises a second measurement element 312 which measures an electrical signal U (the weight input) received from one or more neurons in the first layer 308 and optionally converts the measurement into digital form using an analog to digital converter before sending the measurement to measurement and update element 320.

The measurement and update element 320 in some cases is analog only and receives an analog signal V from the first measurement element 314 and an analog signal U from the second measurement element 312. In this case, where the measurement and update element 320 is analog it comprises an analog combiner. The analog combiner receives the analog signals U and V and produces an output signal which may be a voltage, a current, a voltage pulse or a plurality of voltage pulses which is input to the programmable electronic element of the neuron and updates the programmable element of the neuron. In an example, a total area (integral) of the voltage pulses produced by the analog combiner is related to the combination of U and −V such as by being proportional to the product of U and −V. By using analog only processing there is improved efficiency and accuracy since noise and computational expense of analog to digital conversion is avoided. Where the measurement and update element 320 is analog only, the programmable elements may be updated just in time, where the updates to the programmable elements do not significantly influence the measurements of U and V. That is, an update may be made to a programmable element in one neuron even though U and V have not yet been measured in another neuron of the analog neural network. Alternatively, multiple measurements (for up to every neuron in the analog neural network) may be stored in some analog form (for example, as charge in different capacitors), before being used to perform updates for each neuron. In this way, updates to every neuron are based on measurements (of U, V) made prior to any updates being begun.

In some cases the measurement and update element 320 comprises an analog combiner which receives the analog signals U and V and produces an output signal which programs the programmable electronic element directly if the programmable electronic element is a device that can be programmed with an analog signal (such as a memristor) or is converted to a digital signal using an analog to digital converter if the programmable electronic element is a device programmed with a digital signal (such as a potentiometer). In cases where U is designed to be non-negative, it is possible to simplify the circuit to improve efficiency, such as by omitting the analog combiner and using only V to program the programmable electronic element (as itself, i.e., analog signal or converted to digital signal, depending on how the programmable electronic element is designed to be programmed).

In some examples the measurement and update element 320 is digital. In this case the electrical signals U and V are converted to digital form using analog to digital converters before being sent to the measurement and update element. The measurement and update element computes an update ΔW to be applied to the programmable element of the neuron. The update ΔW is computed according to the following relationship where the symbol a denotes a learning rate and is a constant which is determined empirically, set by a host computing device hosting the analog neural network or configured during manufacture:

$$Δ W = - α ( U * V )$$

In some examples, where the measurement and update element 320 is digital, a memory is used to store the computed update ΔW which is to be applied to the neuron. The same is done for other neurons in the neural network so that there is a value of ΔW computed and stored for each neuron to be updated. The updates ΔW are then applied after U and V have been measured for neurons which are to be updated in the neural network. In this way, the measurements of U and V, obtained before the updates ΔW to be applied, are not influenced by the later updates ΔW to the programmable elements.

In some cases where the measurement and update element 320 comprises an analog combiner which receives the analog signals U and V and produces an output signal. The updates ΔW are then applied (such as by pulsing the programmable elements) after U and V have been measured for the neurons which are to be updated in the neural network. In this way, the measurements of U and V are not influenced by the updates ΔW to the programmable elements.

In various examples, U and V are used to perform some computation to produce the target/change to program the programmable electronic element. The computations may be done in digital space or analog space: in digital space, it means U and V are converted with an analog-to-digital conversion to digital signals, and the computations are performed in digital space; in analog space, it means the same computation is realised with analog operators (for example, different operational amplifiers), thus, without any analog-to-digital conversion. For example, to produce the change of the programmable electronic element to be proportional to −U*V. If the computation is done in digital space, U and V may be converted with an analog-to-digital conversion to digital signals, −U*V are then computed in the digital space. If the computation is done in analog space, U and V are connected to an analog combiner to produce a combination of U and V in the analog space. After the above computation of the target/change, to program to the programmable electronic element, the results of the computation are used to actually program the programmable electronic element. How the results program the programmable electronic element depend on the type of programmable electronic element: some examples use a digital signal to program (for example, a digital potentiometer requires a series of digital signals to program), some examples use an analog signal (for example, memristor conductance is programmed with analog voltage pulses). The results of the computation are converted to the corresponding signal to program the programmable electronic element. As an example, −U*V are computed in analog space with an analog multiplier, the programmable electronic element is a memristor that can be programmed with the produced −U*V in analog space, in this example, training happens in analog space with minimal conversions so resulting in an extremely fast training of neural networks.

In an example, ‘clamping’ of the neural network output is performed by applying an additional voltage source directly to the output units of the network. This voltage is calculated so as to take the equilibrium voltage of an unclamped equilibrium and set it to a desired target voltage. This additional voltage provided at the output modifies the equilibrium voltages throughout the network. In effect, circuit physics results in voltage being ‘distributed’ backwards through the cascade of analog layers. The inventors recognize that the voltage across the error element (V), or the change of voltage across the error element caused by the clamping of the output (V-Error_f) is an error signal for learning. Changes in voltage that are part of the signal for learning are measured by using measurement elements 312, 314 whenever an error signal is desired to be read off to update a weight.

In FIG. 3 the neural network is being trained as the output 316 is clamped to an electrical signal which represents a ground truth label of a training data item being used to train the neural network. Thus in FIG. 3 the input 310 is clamped to an electrical signal representing the training data item and the output 316 is clamped to an electrical signal representing a ground truth label of the training data item.

In an example where the first measurement element 314 measures a voltage difference V, denote the weight with W, and denote the error as V. U is the weight input of the neuron. In the case of the input layer only, U is equal to the input 310.

The mathematical interpretation of V (i.e. Error) is that, Error=(U*W)−Target where, for the last layer, Target is a voltage representing a ground truth label of a neural network training example being used to train the analog neural network. For other layers, Target is the target output of the particular layer concerned so that the last layer can produce the ground truth label. Thus a first learning rule is expressed as,

$$Loss = 0.5 * {Error}^{2} = 0.5 * {( U * W - Target )}^{2}$$

$$Change of weight \sim - d Loss / d W = - Error * U$$

Therefore, in an example the measurement and update element increments a weight of the neuron by U times V and optionally multiplied by a learning rate a. Note that U may be positive or negative.

FIG. 3A shows part of a circuit used to implement a second learning rule which seeks to keep error constant. In some embodiments the arrangement of FIG. 3 is modified by substituting element 314 by measurement and storage blocks 314A and 314B shown in FIG. 3A and introducing an analog differencer 326 as shown in FIG. 3A. Measurement and storage blocks 314A and 314B are analog blocks. In these embodiments the analog neural network uses a learning rule which seeks to keep the error constant or “still” as now explained. Each measurement and storage block 314A and 314B of FIG. 3A shows an error element which corresponds to a single error element of the second neural network layer 318 of FIG. 3 (i.e each measurement and storage block 314A and 314B may use the same error element of the second neural network layer). The error element of the measurement and storage blocks of FIG. 3A is connected in series with an amplifier and a non-linear element although the amplifier and non linear element are not shown in FIG. 3A. Thus a single error element is connectable to two distinct measurement and storage blocks 314A and 314B. Each measurement and storage block 314A, 314B records an analog electrical quantity measured across the single error element. One of the measurement and storage blocks 314A records the analog electrical quantity across the error element in an operating state where the output of the neural network is clamped. The other of the measurement and storage blocks 314B records the analog electrical quantity across the error element in an operating state where the output of the neural network is not clamped. The stored values are both provided as inputs to an analog differencer 326 which outputs a quantity related to, such as by being proportional to the difference between the stored values, shown in FIG. 3A. The measurement and storage blocks 314A, 314B are capable of storing an analog quantity and in some implementations may be capacitors. The analog differencer produces an output generally equal or generally proportional to the difference between two analog inputs. In another implementation where these inputs are voltage levels, this may be a differential amplifier.

The inventors have devised a second learning rule which works very well in practice and is used in place of the first learning rule in some examples. The first learning rule comprises two equations (given above) which seek to change the weight to reduce the error. It is possible to have a learning rule, referred to herein as a second learning rule, that tries to keep the error still or constant instead of aiming to reduce the error as now explained.

In a forward pass of training process for training an analog neural network, when the input to the neural network is clamped but the output of the neural network is not clamped, there are unavoidable current flows over the error elements. Thus, even in a forward pass of an analog neural network, such as those described herein, error is not zero. A second learning rule which seeks to keep the error constant or “still” is therefore used as follows. Denote the error in the forward pass as Error_f, the second learning rule is:

$$Change of weight \sim = - d Loss / d W = - ( Error - Error\_f ) * U$$

Which is expressed in words as, update the programmable electronic element by a change of weight which is approximately equal to the negative difference between the error observed when the analog neural network is at equilibrium with both the first clamp and the second clamp in place, and the error observed when the analog neural network is at equilibrium with only the first clamp in place, times the weight input U.

The error in the forward pass Error_f is measured using measurement element 314A. In the equation above Error denotes the same quantity as V in this document.

Here, if Error=Error_f, the weights are not updated, i.e. the learning rule tries to keep the error as it was in the forward pass. In implementing this to analog hardware, a component that detects the temporal change of Error from the forward pass (at the end of the first clamp) to the phase when the second clamp is applied at the same time as the first clamp. This is done in some examples with analog measurement and storage blocks 314A, 314B as illustrated in FIG. 3A; in some examples these components are implemented as capacitors and a differential amplifier, respectively. Analog quantities Error_f and Error are measured and stored in the measurement and storage blocks 314A, 314B and subsequently passed as inputs to the analog difference 326. In this way, the output of the analog differencer reflects the temporal change of voltage drop across the error element, i.e., (Error-Error_f). This signal is processed either digitally or in analog form to multiply with U and produce the eventual change of weight as defined in the above equation.

The change of weight computed using the second learning rule is used to update the programmable electronic element. The update is done in the analog domain in some examples. In some examples the update is done in the digital domain.

The first and second learning rules are combinable. That is, an analog neural network is able to use the first learning rule for some training examples and the second learning rule for other training examples of the same training data set.

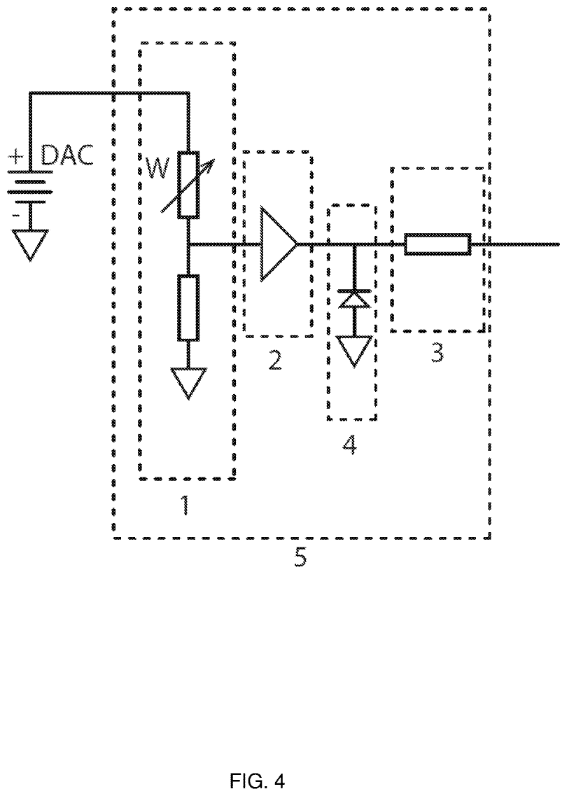

FIG. 4 is a circuit diagram of an example of a layer 400 of an analog neural network. As for FIG. 2 the layer 400 comprises a programmable element 1, an amplifier block 2, a non-linear element 4 and an error element 3. FIG. 4 illustrates how the order in which the elements are connected in series to form a neuron is different from that of FIG. 3. In FIG. 4 there is a digital to analog converter which converts an input digital signal into an input signal of the layer 400. In the case the layer is an internal layer of a neural network the digital to analog converter is absent. The inventors have found that any order may be used to connect the elements in series to form a neuron. This gives significant benefits as the order can be tailored to particular space and topology requirements.

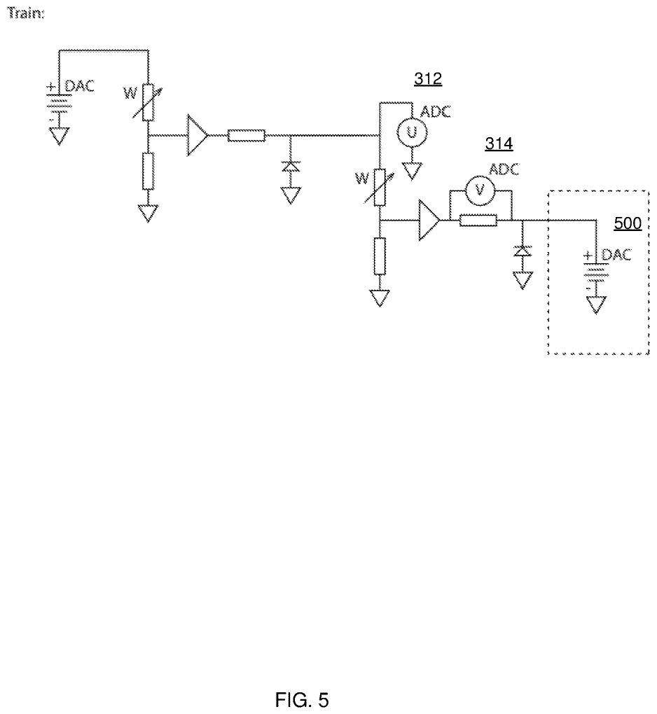

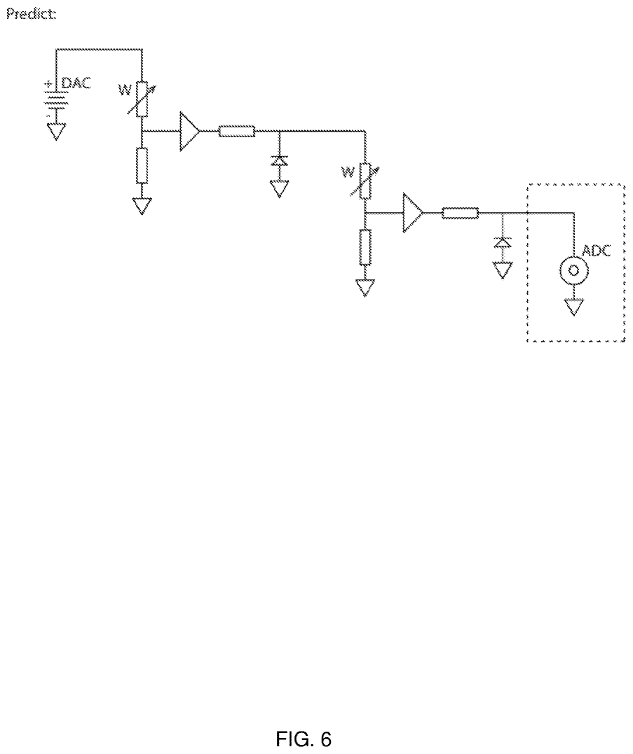

FIG. 5 is a circuit diagram of an analog neural network with two layers and suitable to train the analog neural network. The arrangement of FIG. 5 is the same as that of FIG. 3 and is formatted in a similar way as for FIG. 6 in order to aid comparison with FIG. 6.

FIG. 6 is a circuit diagram of an analog neural network with two layers and suitable to compute a prediction. The electrical elements and neural network architecture of FIG. 6 is the same as for FIG. 5 and FIG. 3. However, in FIG. 6 the output of the neural network 600 is different since it is not clamped to a target value and comprises means to read the electrical signal at the output and optionally, an analog to digital converter to convert the electrical signal to digital form. The digital signal is then stored or passed to a downstream process such as an application at a host computing device hosting the analog neural network.

FIG. 7 is a circuit diagram of a plurality of programmable electronic elements 700, 702, 704 in a layer of an analog neural network. Three programmable electronic elements are shown although in practice there are tens or hundreds of such elements. The programmable electronic elements are each inputs to the same neuron which has an amplifier block 706, error element 708 and non-linear element 710. A benefit of the arrangement of FIG. 7 is that a single error element 708 is used to update the weights of a plurality of programmable electronic elements.

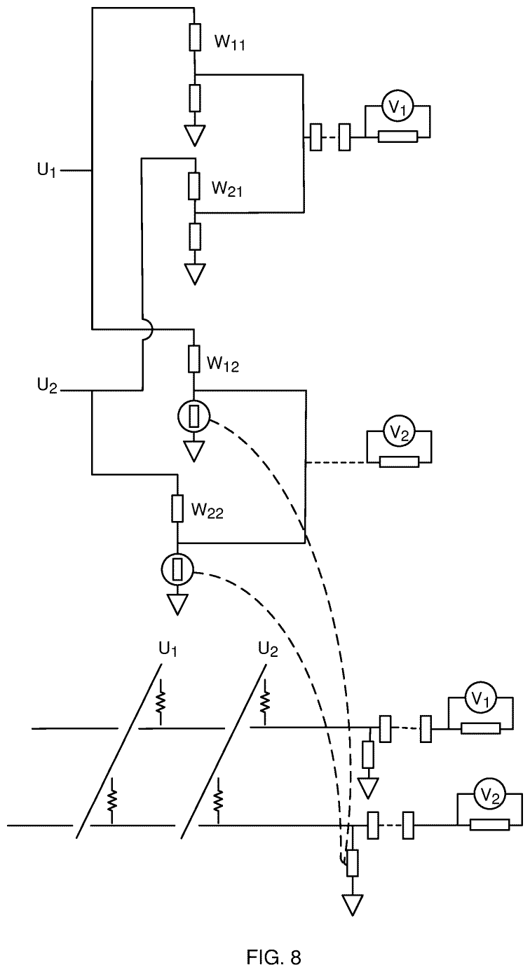

FIG. 8 is a circuit diagram of two neurons in a layer of an analog neural network. The circuit diagram is shown in a first format in the upper half of FIG. 8 and in a second format using a cross-bar array notation, in the lower half of FIG. 8. As shown in the upper half of FIG. 8, each neuron has two programmable electronic elements. Programmable electronic elements W11 and W12 (in the same neuron) both receive weight input U1 from the previous layer of the analog neural network. Programmable electronic elements W21 and W22 both receive weight input U2 from the previous layer of the analog neural network.

Programmable electronic elements W11 and W21 are part of the same neuron which comprises an amplifier block, a non-linear element, an error element, and a measurement element as indicated. An update to programmable electronic element Wij is computed as

$$Δ {W}_{ij} ∼ - {U}_{i} {V}_{j}$$

Programmable electronic elements W12 and W22 are part of the same neuron which comprises an amplifier block, a non-linear element, an error element, and a measurement element as indicated.

The lower half of FIG. 8 shows the equivalent circuit using cross-bar array notation. The two neurons are shown in a cross-bar array and each neuron has an amplifier block and a non-linear element as shown. In the upper half of FIG. 8 each programmable element has a resistor whereas in the lower half of FIG. 8 these are consolidated into a single resistor per neuron as indicated by the dotted arrows. The dotted short lines indicate non-linear element and amplifier blocks.

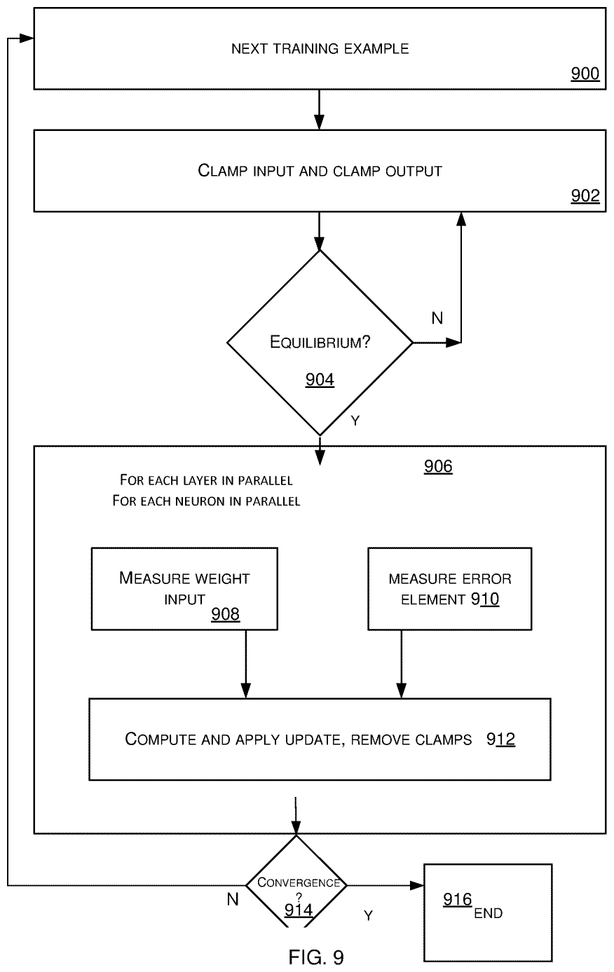

FIG. 9 is a flow diagram of a method of training an analog neural network such as any of the analog neural networks described herein. A next training example is received 900 from a host machine. The training example is a labelled training example in the case of supervised learning. The training example is from a store or stream of training examples to be used for training the neural network. An electrical signal corresponding to the training example is obtained and clamped 902 to the input of the whole neural network (310 of FIG. 3). The electrical signal represents the training example and is in the form of a voltage or a current or other electrical signal. The output of the neural network (316 of FIG. 3) is clamped 902 to an electrical signal representing the ground truth value of the training example; that is, the label of the training example.

The electrical signals from the clamped input and clamped output propagate through the analog neural network layers. The electrical signal from the clamped input propagates forwards towards the output of the neural network. The electrical signal from the clamped output propagates back towards the input of the neural network. Eventually the propagating signals reach an equilibrium in the analog neural network. A check 904 is made as to whether an equilibrium has been reached whilst the analog neural network is in the dual clamped state. The check is done by waiting for a specified time (which may be very short) and assuming that the equilibrium has been reached. Or in some cases the check is done by taking repeated measurements of an electrical signal in the analog neural network and checking whether the measurements are similar.

Once the equilibrium has been reached in the dual clamped state, for each layer of the analog neural network in parallel, and for each neuron within each layer, a measurement and update process occurs as shown in block 906 of FIG. 9. Note it is not essential for all the updates to be applied in parallel.

The measurement and update process of block 906 comprises, for each neuron, measuring 908 a weight input U of the neuron. The measurement and update process of block 906 comprises, for each neuron, measuring an error element V 910 of the neuron.

During the transition into the equilibrium at the dual clamped state each error element stores information about an amount of change in the electrical signal at the error element. In an example the error element is a capacitor which stores charge or a resistor.

Measurements 910 are taken from the error elements such as by reading a voltage difference over a resistor or a voltage difference over a capacitor. Measurements 908 of the input weights are made by reading a voltage as indicated in FIG. 3 at 312 or in other ways.

The measurements from the error elements are made available to a measurement and update element as described with reference to FIG. 3. The measurements of the weight inputs are also made available to the measurement and update element. The measurement and update element computes and applies an update 912 to the programmable electronic elements in order to update weights of the neural network. The clamps are then removed from the input 310 and from the output 316.

The inventors have found that the amount of change in the electrical signal measured from the error elements is related to a gradient signal for training the neural network, with weight updates which are related to the size of the difference between the neural network's natural equilibrium output under the first (input) clamping, and the target output. Thus, by updating the weights of the neural network in a manner taking into account the measurements from the error elements it is possible to train the neural network.

A check 914 is made to see if convergence has been reached such as by checking whether the update made to the programmable electronic elements was below a threshold or whether a predetermined number of training examples has been used. If convergence has been reached the training ends 916. Otherwise the process of FIG. 9 repeats for another training example.

Since the method of FIG. 9 performs credit assignment using hardware physics directly, it automatically incorporates information about the variability of the devices that comprise the circuit. This means that unlike naive backpropagation updates, the updates computed by the method of FIG. 9 have perfectly ‘corrected’ for many types of variability/imperfection found ubiquitously in analog electronic devices. The method thus enables effective and robust end-to-end training of analog neural networks.

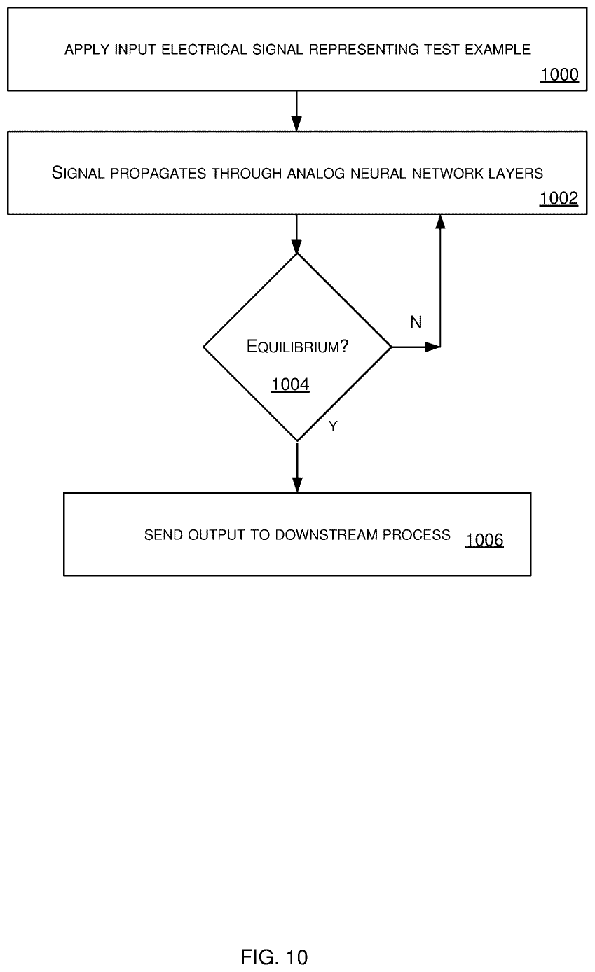

FIG. 10 is a flow diagram of a method of computing an inference using an analog neural network. During the method of FIG. 10 there is no clamping of the neural network output.

An input electrical signal is applied 1000 to an input of the neural network such as by clamping the electrical signal to the neural network input (e.g. 310 of FIG. 3). The input represents a test time example (that is, an example that was not used during training or validation). As a result of the input electrical signal being applied the signal propagates 1002 through the analog neural network layers from the input towards the output of the neural network. A check 1004 is made as to whether an equilibrium or steady state has been reached in the neural network. The check may comprise waiting for a specified time and assuming the equilibrium has been reached. In response to the equilibrium being reached the electrical signal at the output of the neural network is read and stored or sent to a downstream process 1006. Optionally the stored signal is converted from analog to digital using an analog to digital converter.

Implementation of a neural network end-to-end directly in analog circuitry gives a substantial speed-up of inference time (supplying the network with inputs and computing its output) over state of the art GPUs by several orders of magnitude. This is because inference time in end-to-end analog networks is determined by the equilibration time of a circuit, which is on the order of nanoseconds, and is performed in analog by physics rather than sequentially simulated on a digital computer.

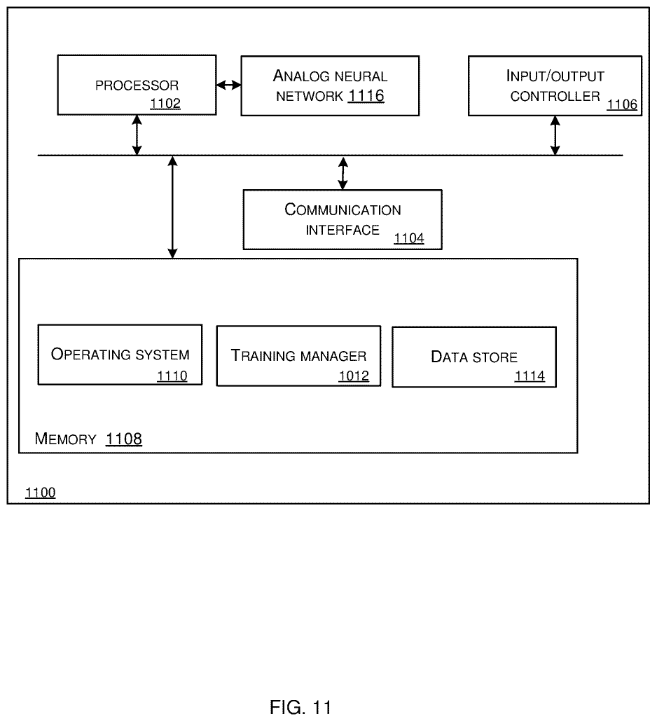

FIG. 11 is a schematic diagram of a host computing device 1100 hosting an analog neural network 1116.

Host computing device 1100 comprises one or more processors 1102 which are microprocessors, controllers or any other suitable type of processors for processing computer executable instructions to control the operation of the device in order to manage a neural network training programme and/or manage a service which uses analog neural network functionality. Platform software comprising an operating system 1110 or any other suitable platform software is provided at the host computing device 1100 to enable application software such as neural network training manager 1112 to be executed on the device.

The computer executable instructions are provided using any computer-readable media that is accessible by host computing device 1100. Computer-readable media includes, for example, computer storage media such as memory 1108 and communications media. Computer storage media, such as memory 1108, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 1108) is shown within the host computing device 1100 it will be appreciated that the storage is, in some examples, distributed or located remotely and accessed via a network or other communication link (e.g. using communication interface 1104).

The host computing device 1100 also comprises an input/output controller 1106 arranged to output display information to a display device which may be separate from or integral to the host computing device 1100. The display information may provide a graphical user interface to show predictions generated using the analog neural network. The input/output controller 1106 is also arranged to receive and process input from one or more devices, such as a user input device (e.g. a mouse, keyboard, camera, microphone or other sensor).

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

Where the description has explicitly disclosed in isolation some individual features, any apparent combination of two or more such features is considered also to be disclosed, to the extent that such features or combinations are apparent and capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. An analog neural network comprising:
a plurality of layers connected to form an electrical circuit having an input and an output, the input suitable for receiving an electrical signal corresponding to an input example, being a training example, and the output corresponding to an output of the neural network;
each layer comprising elements connected together, where the elements comprise:
at least one programmable electronic element representing a weight of the neural network;
at least one non-linear element;
at least one amplifier block;
an error element;
and wherein each layer also comprises:
a first measurement element for measuring an electrical signal V of the error element, and
a second measurement element for measuring a weight input U of the programmable electronic element; and
wherein the analog neural network comprises:
a first clamp for clamping the input to the electrical signal corresponding to the input example;
a second clamp for clamping the output to an electrical value, the electrical value representing a ground truth label of the input example; and
a measurement and update element comprising functionality to, in response to the first and second clamps being active and the electrical circuit being in a steady state, receive input from the first and second measurement elements and to update the programmable electronic element using the input from the first and second measurement elements, wherein the measurement and update element the measurement and update element is digital and uses a digital process to compute updates of weights.

2. The analog neural network of claim 1 wherein the measurement and update element is arranged to update the programmable electronic element using at least the input V from the first measurement element and the input U from the second measurement element in order to train the neural network.

3. The analog neural network of claim 1 wherein the error element comprises any one or more of: a capacitor, a resistor.

4. The analog neural network of claim 1 wherein the measurement and update element uses a memory to store computed updates to be applied to programmable electronic elements of the analog neural network.

5. The analog neural network of claim 1 wherein the programmable electronic element, non-linear element, amplifier block and error element are connected in series in any order.

6. The analog neural network of claim 1 wherein the measurement and update element is configured to make an update to a programmable electronic element in one neuron of the analog neural network before measurement of U and V in another neuron of the analog neural network.

7. The analog neural network of claim 1 wherein the measurement and update element is configured to make an update to a programmable electronic element only after measurement of U and V for neurons of the analog neural network to be updated.

8. A method of training the analog neural network of claim 1, the method comprising:
clamping the electrical signal at the input to an electrical signal representing the training example;
further clamping the output to the electrical value representing the label of the training example, and
in response to the electrical circuit being in a steady state, measuring electrical signal V and electrical signal U; and
updating the programmable electronic element using V and U.

9. The method of claim 8 wherein using the measurement to update the programmable electronic element comprises applying the measurement in analog form to the programmable electronic element.

10. The method of claim 9 further comprising:
in response to clamping the electrical signal at the input to an electrical signal representing the training example, whilst the output is not clamped,
measuring an electrical signal Error_f using the first measurement element; and
updating the programmable electronic element using V and U and Error_f.

11. A method of operating the analog neural network of claim 1 to compute a prediction, the method comprising:
clamping the electrical signal at the input to an electrical signal corresponding to an input example; and
in response to the electrical circuit being in a steady state, outputting an analog signal at the output.

12. A method performed by an analog neural network for training the analog neural network comprising:
receiving an electrical signal corresponding to an input example, being a training example, at an input of an electrical circuit comprising a plurality of layers;
within each layer, processing the electrical signal by passing the electrical signal through a plurality of elements connected together, where the elements comprise:
at least one programmable electronic element representing a weight of the neural network;
at least one non-linear element;
at least one amplifier block;
an error element;
a first measurement element;
a second measurement element; and
wherein the method comprises
using a first clamp to clamp the electrical signal at the input to the electrical signal corresponding to the input example;
using a second clamp to clamp an output of the electrical circuit to an electrical value representing a ground truth label of the input example; and
in response to the first and second clamps being active and an equilibrium state in the analog neural network, using the first measurement element to obtain an electrical signal V of the error element, and using the second measurement element to obtain a weight input U of the programmable electronic element using an analog combiner.

13. The method of claim 12 comprising:
using U and V to update the programmable electronic element using an analog update.

14. The method of claim 12 wherein the analog combiner produces one or more voltage pulses which are input to the programmable electronic element.

15. The method of claim 12 comprising
in response to clamping the electrical signal at the input to an electrical signal representing the training example, whilst the output is not clamped,
measuring an electrical signal Error_f using the first measurement element; and
updating the programmable electronic element using V and U and Error_f.

16. The method of claim 15 wherein updating the programmable electronic element using V and U and Error_f comprises updating the programmable electronic element by a change of weight which is approximately equal to the negative difference between the error V observed when the analog neural network is at equilibrium with both the first clamp and the second clamp in place, and the error Error_f observed when the analog neural network is at equilibrium with only the first clamp in place, times the weight input U.
